(19) United States
(12) Patent Application Publication
(10) Pub. No.: US 2024/0036821 A1
(43) Pub. Date: Feb. 1, 2024

(54) FLOATING-POINT NUMBER DECODER

(71) Applicant: Arm Limited, Cambridge (GB)

(72) Inventors: Neil Burgess, Cardiff (GB); Sangwon Ha, Cambridge (GB); Partha Prasun Maji, Cambridge (GB)

(73) Assignee: Arm Limited, Cambridge (GB)

(21) Appl. No.: 18/199,151

(22) Filed: May 18, 2023

(30) Foreign Application Priority Data
Aug. 1, 2022 (GB) 2211214.8

(51) Int. Cl. G06F 7/483

(52) U.S. Cl. CPC G06F 7/483

(57) ABSTRACT

In a data processor, an input datum, having a sign, a tag and a payload, is decoded by first determining a format of the payload based on the tag. For a first format, an exponent difference and an output fraction are decoded from the payload. For a second format, an exponent difference is decoded from the payload and the output fraction may be assumed to be zero. The exponent difference is subtracted from a shared exponent to produce the output exponent. The decoded output may be stored in a standard format for floating-point numbers.

### BACKGROUND

A Block Floating-Point (BFP) number system represents a block of floating-point (FP) numbers by a shared exponent (typically the largest exponent in the block) and right-shifted significands of the block of FP numbers. Computations using BFP can provide improved accuracy compared to integer arithmetic and use fewer computing resources than full floating point. However, the range of numbers that can be represented using a BFP format is limited, since small numbers are replaced by zero when the significands are right-shifted too far.

In some applications, such as computational neural networks, input data may have a very large range. The use of BFP in such applications can lead to inaccurate results. In applications that use a large amount of data, the use of higher precision number representations may be precluded by limitations on storage resources, etc.

### BRIEF DESCRIPTION OF THE DRAWINGS

The accompanying drawings provide visual representations which will be used to more fully describe various representative embodiments, and can be used by those skilled in the art to better understand the representative embodiments disclosed and their inherent advantages. In these drawings, like reference numerals identify corresponding or analogous elements.

FIG. 1 is a representation of a block of Enhanced Block Floating Point (EBFP) numbers, in accordance with various representative embodiments.

FIGS. 2A and 2B are diagrammatic representations of computer storage of an EBFP number, in accordance with various representative embodiments.

FIGS. 3A and 3B are diagrammatic representations of computer storage of an EBFP number, in accordance with various representative embodiments.

FIG. 4 is a block diagram of an apparatus for converting an enhanced block floating-point number into a floating-point number, in accordance with various representative embodiments.

FIG. 5 is a block diagram of a first decoder, in accordance with various representative embodiments.

FIG. 6 is a block diagram of a second decoder, in accordance with various representative embodiments.

FIG. 7 is a flow chart of a computer-implemented method for converting an enhanced block floating point (EBFP) number into a floating-point (FP) number, in accordance with various representative embodiments.

FIG. 8 is a flow chart of a method for converting a floating-point number into a number in an IEEE format, in accordance with various representative embodiments.

FIG. 9 is a block diagram of apparatus for converting a floating-point number into a number in an IEEE format, in accordance with various representative embodiments.

### DETAILED DESCRIPTION

The various apparatus and devices described herein provide mechanisms for data processing using and enhanced block floating point data format.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements.

A number may be represented as (−1)^{s}×m×b^{e}, where s is a sign value, m is a significand, e is an exponent and b is a base. In some binary (b=2) floating-point representations, such as the 32-bit IEEE (Institute of Electrical and Electronic Engineers) format, the significand is either zero or in the range 1≈m<2. For non-zero values of m, the value m-1 is referred to as the fractional part of the significand. The 32-bit IEEE format stores the exponent as an 8-bit value and the significand as a 23-bit value.

A Block Floating-Point (BFP) number system represents a block of floating-point (FP) numbers by a shared exponent (typically the largest exponent in the Block) and right-shifted significands of the block of FP numbers. The present disclosure improves upon BFP by representing small FP numbers (that would ordinarily be set to zero) by the difference between the exponent and the shared exponent. A tag bit indicates whether the EBFP number represents a shifted significand or the exponent difference.

Some data processing applications, such as Neural Network (NN) processing, require very large amounts of data. For example, a single network architecture can use millions of parameters. Consequently, there is great interest in storing data as efficiently as possible. In some applications, for example, 8-bit scaled integers are used for inference but data for training requires the use of floating-point numbers with a greater exponent range than the 16-bit IEEE half-precision format, which has only 5 exponent bits. A 16-bit “Bfloat” format has been used for NN training tasks. The Bfloat format has a sign bit, 8 exponent bits, and 7 fraction bits (denoted as s,8e,7f). Other FP formats include “DLfloat” which has 6 exponent bits and 9 fraction bits (s,6e,9f) as well as other 8-bit formats having more exponent bits than fraction bits (such as s,4e,3f and s,5e,2f).

Block Floating-Point (BFP) representation has been used in a variety of applications, such as NN and Fast Fourier Transforms. In BFP, a block of data shares a common exponent, typically the largest exponent of the block to be processed. The significands of FP numbers are right-shifted by the difference between their individual exponents and the shared exponent. BFP has the added advantage that arithmetic processing can be performed on integer data paths saving considerable power and area in NN hardware implementation. BFP appears particularly well-suited to computing dot products because numbers with smaller exponents will not contribute many bits, if any, to the result. However, a difficulty with using BFP for processing Convolutional Neural Networks (CNNs) is that output feature maps are derived from multiple input feature maps which can have widely differing numeric distributions. In this case, many or even most of the numbers in a BFP scheme for encoding feature maps could end up being set to zero. By contrast, the weights employed in CNNs are routinely normalized to the range −1 . . . +1. Given that successful training and inference is usually dependent on the highest magnitude parameter of each filter, blocks of weights need exponents to sit only within a relatively small range.

TABLE 1 shows an example dot product computation for vector operands A and B. The number are denoted by hexadecimal significands with radix 2 exponents. Corresponding decimal significands and exponents are shown in brackets. The maximum of each vector is shown in bold font.

TABLE 1
Dot Product for Real Numbers

| Op A | Op B | OpA × OpB |
|---|---|---|
| +0 × 1.39p − 17 (1.22 × 2⁻¹⁷) | −0 × 1.40p − 5 (−1.25 × 2⁻⁵) | −0 × 1.8740p − 22 (−1.53 × 2⁻²²) |
| −0 × 1.ccp + 20 (−1.80 × 2²⁰) | +0 × 1.fap − 6 (1.98 × 2⁻⁶) | −0 × 1.c69cp + 15 (−1.78 × 2¹⁵) |
| +0 × 1.bbp + 7 (1.73 × 2⁷) | +0 × 1.dep + 19 (1.87 × 2¹⁹) | +0 × 1.9d95p + 27 (1.62 × 2²⁷) |
| −0 × 1.d8p + 11 | −0 × 1.49p + 0 | +0 × 1.2f4cp + 12 |
| +0 × 1.dfp − 12 | +0 × 1.8cp − 10 | +0 × 1.727ap − 21 |
| −0 × 1.d9p + 19 (−1.85 × 2¹⁹) | −0 × 1.0ap + 9 | +0 × 1.eb7ap + 28 |
| +0 × 1.f2p − 17 | −0 × 1.41p + 13 (−1.25 × 2¹³) | −0 × 1.3839p − 3 |
| +0 × 1.d1p − 7 | +0 × 1.ecp − 20 | +0 × 1.bed6p − 26 |
| | Result | +0 × 1.5d1bp + 29 |

TABLE 2 shows the same dot product computation for vector operands A and B performed using Block Floating Point arithmetic. In this example, the dot product is calculated as zero because a number of small operands are represented by zero in the Block Floating Point format.

TABLE 2
Dot Product using Block Floating Point

| Op A (p + 20) | Op B (p + 19) | Op A × Op B |
|---|---|---|
| 0 | 0 | 0 |
| −0 × 1.cc (−1.80) | 0 | 0 |
| 0 | +0 × 1.de (1.87) | 0 |
| 0 | 0 | 0 |
| 0 | 0 | 0 |
| −0 × 0.ed (−0.93) | 0 | 0 |
| 0 | −0 × 0.05 (−0.02) | 0 |
| 0 | 0 | 0 |
| | BFP Result | 0 |

This example illustrates that conventional Block Floating Point arithmetic is not well suited for use where the data has a large range of values.

The present disclosure uses a number format, referred to as Enhanced Block Floating Point (EBFP). The format may be used in applications such as convolutional neural networks where (i) individual feature maps have widely differing numeric distributions and (ii) filter kernels only require their larger parameters to be represented with higher accuracy.

In accordance with various embodiments, the exponent of a floating number to be encoded is compared with the shared exponent: when the difference is large enough that the BFP representation would be zero due to all the significand bits being shifted out of range, the exponent difference is stored; otherwise, the suitably encoded significand is stored.

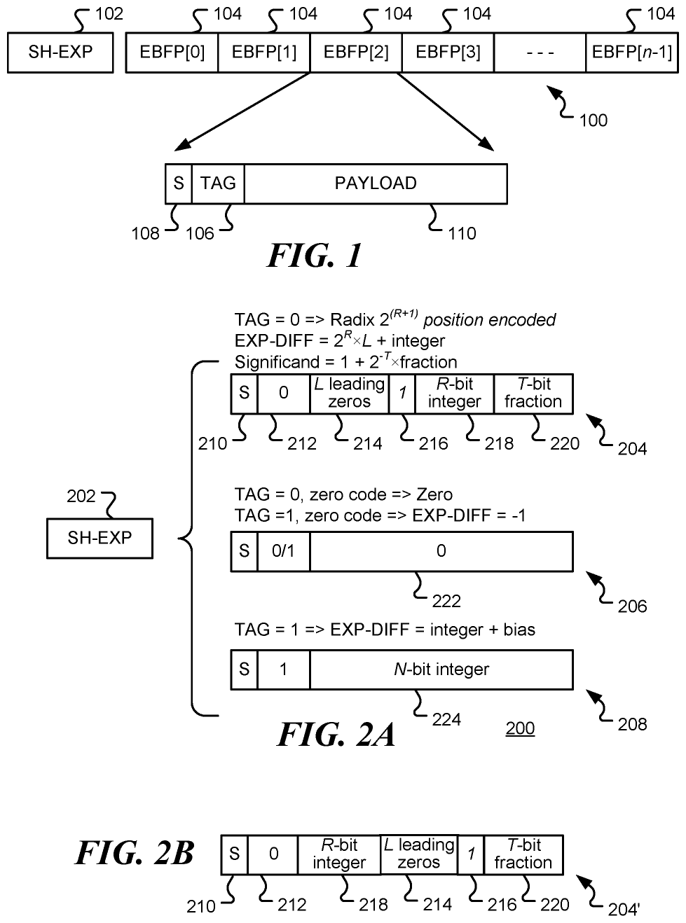

FIG. 1 is a representation of a block of Enhanced Block Floating Point (EBFP) numbers 100. Each number is represented by shared exponent 102 and an M-bit word 104, where M is an integer such as 8 or 16 for example. Word 104 includes one or more tag bits 106, a sign bit 108 and a number of bits for storing a payload 110 indicative of either the exponent difference or an encoded significand. For example, a number may be represented by an 8-bit base exponent and an 8-bit word having one or two tag bits, a sign bit and 5 or 6 bits for storing either the exponent difference or the encoded significand. In this example, the EBFP format implements a floating-point number system with 5 or 6 exponent bits and 1 to 6 significand bits. In contrast to prior formats, the allocation of payload bits between exponent bits and significand bits is variable.

In accordance with an embodiment of the disclosure, an input datum in EBFP format is converted into a number in floating-point format in a data processor. A payload of the EBFP number can be in a first format or a second format. The format of an input datum is determined based on a tag value of the input datum. For the first format, an exponent and significand of a floating-point number are determined, based on a payload of the input datum and a shared exponent. For the second format, the exponent of the floating-point number is determined, based on the payload of the input datum and the shared exponent. In this case, the floating-point number has a designated significand, such as the value “1.” The output floating-point number consists of a sign copied from the input datum, the exponent of the floating-point number and the significand of the floating-point number.

The EBFP format is described in more detail below with reference to an apparatus for converting an EBFP number to a floating-point (FP).

FIG. 2A is a diagrammatic representation of computer storage 200 of an EBFP number, in accordance with various representative embodiments. The embodiment shown uses a single tag bit. The storage includes a shared exponent (SH-EXP) 202 and payloads (selectable words) 204, 206 and 208.

First word 204 includes sign bit 210, 1-bit tag 212, and a payload consisting of fields 214, 216, 218 and 220. The tag bit 212 is set to zero to indicate that the payload is associated with a significand. Fields 214, 216 and 218 indicate a difference between the shared exponent 202 and the exponent of the number being represented. Field 214 contains L zeros, where L may be zero. Field 216 contains a “one” bit, and field 218 contains an R-bit integer, where R is a designated integer. The factor 2^{(R+1)} is called the “radix” of the representation, so the radix is 2 when R=0, 4 when R=1, and 8 when R=2. Field 218 is omitted when R=0. The exponent difference is given by 2^{R}×L+P. Field 220 is a rounded and right-shifted fractional part of the significand. The total number of bits in the payload is fixed. Since the number of zeros in field 214 is variable, the number of bits, T, in the fraction field varies accordingly. When the integer value of field 220 is F, the significand is given 1+2^{-T}×F, which may be denoted by 1.fff . . . f. Thus, when the shared exponent is se, the number represented is:

x=2^{se}×2⁻⁽²^{^{R}}^{L+P)}×(1+2^{-T}×F).

Thus, a decoder can determine the represented number by determining L, P and F from an EBFP payload. In one embodiment, the designated number R is zero and the radix is two. In this case

x=2^{se}×2^{L}(1+2^{-T}×F),

and the payload is simply the right-shifted significand. The exponent difference may be determined by counting the number of leading zeros in the EBFP number.

In second payload 206, the payload 222 is set to zero. When the tag bit is zero, the payload represents the number zero. When the tag bit is one, the payload represents an exponent difference of −1. This can occur when rounding causes the maximum value to overflow. Thus, the number represented is 2^{se+1}.

In payload 208, the tag bit is set to one to indicate that the payload 224 relates only to the exponent difference. When the payload is an integer E, the number represented is 2^{se+E+bias}, where bias is an offset or bias value. The bias value is included since some small values of exponent difference can represented by payload 204.

TABLE 3 shows how exponent difference and significand values are determined from a payload for an example implementation, where the payload has 8 bits and includes a sign bit, a tag bit and 6 payload bits. In this example, R=0, so the radix is 2. The format is designated “8r2”. In the table below, “f” denotes fractional bit of the input value and “e” denotes one bit of the biased exponent difference.

TABLE 3
EBFP 8r2, 1-bit tag Format

| Input | | Rounded & | |
|---|---|---|---|
| Sign, Tag, | Exponent | Shifted | Notes: |
| Payload[5:0] | Difference | Significand | R = 0, exp-diff = L |
| s 0 1fffff | 0 | 1.fffff | L = 0 |
| s 0 01ffff | 1 | 1.ffff | L = 1 |
| s 0 001fff | 2 | 1.fff | L = 2 |
| s 0 0001ff | 3 | 1.ff | L = 3 |
| s 0 00001f | 4 | 1.f | L = 4 |
| s 0 000001 | 5 | 1.0 | L = 5 |
| X 0 000000 | Any | Zero | |
| s 1 000000 | 0 | 10.0 | Overflow due to rounding |
| s 1 eeeeee | 6-68 | Any | exp-diff = 6 + eeeeee |
| 0 1 111111 | >68 | Any | Underflow |
| 1 1 111111 | | NaN | Not a number |

For zero tag, the bits indicated in bold font indicate the encoding of the exponent difference. In this example, the payload is equivalent to a right-shifted significand, including an explicit leading bit. Note that for an exponent difference greater than 5, the right-shifted significand is lost because of the limited number of bits. For an exponent difference greater than 5, only the exponent difference is encoded with a bias of 6.

In the embodiment shown in TABLE 3, the exponent difference can be decoded from the EBFP number by counting the number of leading zeros in the payload. This operation is denoted as CLZ(payload).

TABLE 4 shows the result of the example dot product computation described above. The exponents and signs of FP values with smaller exponents are retained. The resulting error compared to the true result is 13%. This is much improved compared to conventional BFP, which gave the results as zero. The accuracy of the EBFP approach is sufficient for many applications, including training convolutional neural networks.

TABLE 4
Dot Product using Enhanced Block Floating Point

| Op A (p + 20) | Op B (p + 19) | Op A × Op B |
|---|---|---|
| +0 × 1.0p − 17 (1.00 × 2⁻¹⁷) | −0 × 1.0p − 5 (−1.00 × 2⁻⁵) | −0 × 1.0p − 22 (−1.00 × 2⁻²²) |
| −0 × 1.cc (−1.80 × 2²⁰) | +0 × 1.0p − 6 (1.00 × 2⁻⁶) | −0 × 1.ccp + 14 (−1.80 × 2¹⁴) |
| +0 × 1.0p + 7 (1.00 × 2⁷) | +0 × 1.de (1.87 × 2¹⁹) | +0 × 1.dep + 26 (1.87 × 2²⁶) |
| −0 × 1.0p + 11 (−1.00 × 2¹¹) | −0 × 1.0p + 0 (−1.00 × 2⁰) | +0 × 1.0p + 11 (1.00 × 2¹¹) |
| +0 × 1.0p − 12 (1.00 × 2⁻¹²) | +0 × 1.0p − 10 (1.00 × 2⁻¹⁰) | +0 × 1.0p − 22 (1.00 × 2⁻²²) |
| −0 × 0.ed (−0.93 × 2²⁰) | −0 × 1.0p + 9 (1.00 × 2⁹) | +0 × 1.dap + 28 (1.85 × 2²⁸) |
| +0 × 1.0p − 17 (1.00 × 2⁻¹⁷) | −0 × 0.05 (−0.02 × 2¹⁹) | −0 × 1.40p − 4 (−1.40 × 2⁻⁴) |
| +0 × 1.0p − 7 (1.00 × 2⁻⁷) | +0 × 1.0p − 20 (1.00 × 2⁻²⁰) | +0 × 1.0p − 27 (1.00 × 2⁻²⁷) |
| | EBFP Result | +0 × 1.28bdp + 29 (1.16 × 2²⁹) |

FIG. 2B is a diagrammatic representation of computer storage 204′ of an EBFP number, in accordance with various representative embodiments. EBFP format includes a number of fields. The order of the fields maybe varied without departing from the present disclosure. For example, in FIG. 2B, the R-bit integer field 218 follows the tag 212. The “one” field 216 is used to terminate the L-leading zeros field 214. This field has a variable length. The length of field 220 varies accordingly, with L+T being constant. Other variations will be apparent to those of ordinary skill in the art. In general, the exponent difference and fractional part (if any) are encoded to produce a tag and a payload, with the tag indicating how the payload is to be interpreted.

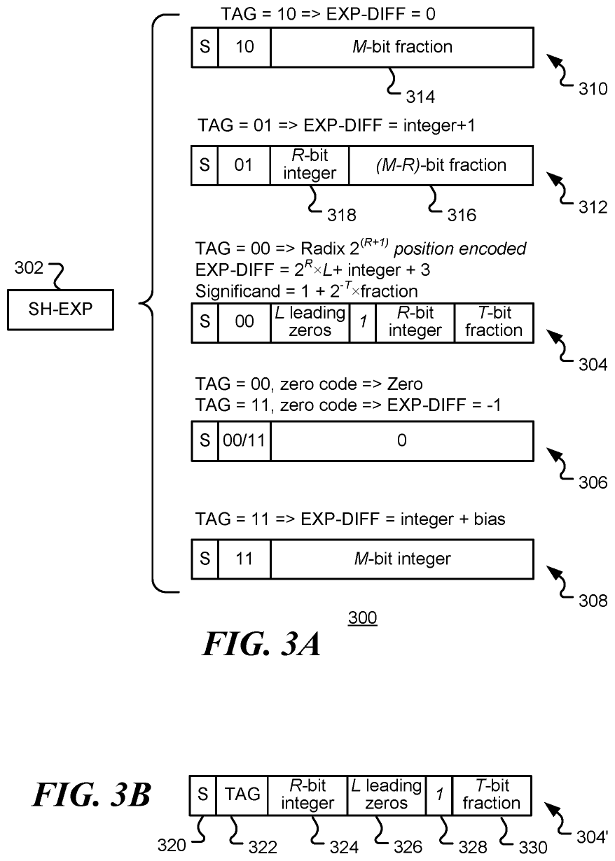

FIG. 3A is a diagrammatic representation of computer storage 300 of an EBFP number, in accordance with various representative embodiments. The embodiment shown uses a 2-bit tag. The storage includes a shared exponent (SH-EXP) 302 and selectable payloads 304, 306, 308, 310, and 312. Payloads 304, 306, 308 correspond to payloads 204, 206 and 208 in the format with a 1-bit tag. However, the bias may be different. The length of the payload is 1-bit shorter because of the extra tag bit. The format includes a first additional payload 310, identified by a tag 10, that stores the fractional part 314 of the significand rounded to M-bits, where M is the length of the payload field. The exponent difference is zero. The format also includes a second additional payload 312, identified by a tag 01, that stores the fractional part 316 of the significand rounded to (M−R+1)-bits, together with an R-bit integer 318. The exponent difference is one. For R=1, the payload is the rounded significand and the exponent difference is one. For R=2, the exponent difference is one when the first bit of the payload is zero, and two when the first bit of the payload is one.

TABLE 5 shows how exponent differences and significands are determined from an input payload for an example implementation, where the payload has 8 bits and includes a sign bit, two tag bits and 5 payload bits. In this example, R=0. In the table below, “f” denotes fractional bit of the input value and “e” denotes one bit of the biased exponent difference. In this embodiment, the exponent difference can be decoded from the EBFP number by counting the number of leading zeros in the tag and payload. This operation is denoted as CLZ(tag, payload).

TABLE 5
EBFP 8r2, 2-bit tag Format

| Input | Output | | Notes: |
|---|---|---|---|
| Sign, Tag[1:0], | Exponent | Output | R = 0, |
| Payload[4:0] | Difference | Significand | exp-diff = CLZ(tag, payload) |
| s 10 fffff | 0 | 1.fffff | CLZ(tag, payload) = 0 |
| s 01 fffff | 1 | 1.fffff | CLZ(tag, payload) = 1 |
| s 00 1ffff | 2 | 1.ffff | CLZ = 2 |
| s 00 01fff | 3 | 1.fff | CLZ = 3 |
| s 00 001ff | 4 | 1.ff | CLZ = 4 |
| s 00 0001f | 5 | 1.f | CLZ = 5 |
| s 00 00001 | 6 | 1.0 | CLZ = 6 |
| X 00 00000 | | Zero | |
| s 11 00000 | 0 | 10.00000 | Overflow due to rounding |
| | | | (L = −3) |
| s 11 eeeee | 7-37 | Any | exp-diff = 7 + eeeee |
| 0 11 11111 | >37 | Any | Underflow |
| 1 11 11111 | | NaN | Not a number |

TABLES 4 and 5 above, illustrate how an output exponent difference and significand can be obtained from a payload.

TABLE 6 shows how output exponent differences and significands are obtained from a payload for an example implementation where the payload has 8 bits and includes a sign bit, a tag bit and 6 payload bits. In this example, R=1, so the radix is 4. In the table below, “f” denotes fractional bit of the input value and “e” denotes one bit of the biased exponent difference.

TABLE 6
EBFP 8r4, 2-bit tag Format

| Input | | | |
|---|---|---|---|
| Sign, Tag[1:0], | Output | | Notes: |
| Payload[4:0] | Exponent | Output | R = 1, |
| P = 0 or 1 | Difference | Significand | exp-diff = 2 × CLZ(tag, payload) + p − 1 |
| s 10 fffff | 0 | 1.fffff | Special case: p = 1 is assumed |
| s 01 pffff | 1 + p | 1.ffff | CLZ = 1 |
| s 00 1pfff | 3 + p | 1.fff | CLZ = 2 |
| s 00 01pff | 5 + p | 1.ff | CLZ = 3 |
| s 00 001pf | 7 + p | 1.f | CLZ = 4 |
| s 00 0001p | 9 + p | 1.0 | CLZ = 5 |
| s 00 00001 | 11 | 1.0 | CLZ = 6, hidden p = 0 |
| X 00 00000 | | Zero | |
| s 11 00000 | 0 | 10.0 | Overflow due to rounding |
| s 11 eeeee | 12-42 | Any | exp-diff = 12 + eeeee |
| 0 11 11111 | >42 | Any | Underflow |
| 1 11 11111 | | NaN | Not a number |

In the examples above, the significand is stored to the right of the encoded exponent difference in the input payload. It will be apparent to those of ordinary skill in the art that alternative arrangements may be used without departing from the present disclosure. For example, in one embodiment, the significand is stored to the left of the encoded exponent difference, and the encoded exponent difference includes L trailing zeros. This is shown in TABLE 7A below. For the encoded exponent in this embodiment the use of one and zeros is reversed. The exponent difference can be decoded by counting the number of trailing zeros in the tag and payload. The exponent difference is decoded as 2×CTZ(tag, payload)+p−1.

TABLE 7A
Alternative EBFP 8r4, 2-bit tag Format

| Input | | | |
|---|---|---|---|
| Sign, Payload[4:0], | Output | | |
| Tag[1:0] | Exponent | Output | R = 1, |
| p = 0 or 1 | Difference | Significand | exp-diff = 2 × CTZ(tag, payload) + p − 1 |
| s fffff 11 | 0 | 1.fffff | CTZ-0, p = 1 |
| s ffffp 10 | 1 + p | 1.ffff | CTZ = 1 |
| S fffp1 00 | 3 + p | 1.fff | CTZ = 2 |
| s ffp10 00 | 5 + p | 1.ff | CTZ = 3 |
| s fp100 00 | 7 + p | 1.f | CTZ = 4 |
| s p1000 00 | 9 + p | 1.0 | CTZ = 5 |
| s 10000 00 | 11 | 1.0 | CTZ = 6, hidden p = 0 |
| X 00000 00 | | Zero | |
| s 00000 01 | 0 | 10.0 | Overflow due to rounding |
| s eeeee 01 | 12-42 | Any | |
| 0 11111 01 | >42 | Any | Underflow |
| 1 11111 01 | | NaN | Not a number |

The payload is made up an encoded exponent difference (shown in bold font) concatenated with a number (possibly 0) of fraction bits (ff . . . f), where the encoded exponent difference includes a number (possibly 0) of bits set to zero, at least one bit set to one, and a number (possibly 0) of additional bits (p).

FIG. 3B is a diagrammatic representation of computer storage 304′ of an EBFP number, in accordance with various representative embodiments. In FIG. 3B, the order of the fields is changed, with the R-bit integer field 324 following the tag field 322. The “one” field 328 is used to terminate the L-leading zeros field 326. Examples of this arrangement are discussed in more detail below.

TABLE 7B, below, shows an example encoding using storage 304′ in FIG. 3B. In this example, the exponent difference is given by 2^{R}×(CLZ+tag)+p, when tag=01, and by 2^{R}×tag+p when tag=00 or 01 (R=1 in this example).

TABLE 7B
Alternative EBFP 8r4, 2-bit tag (R = 1) Format

| Sign:Tag:Payload | Floating-Point Equivalent |
|---|---|
| s 11 ddddd | (−1)^{s} × 1.0 × 2\hat{ } (shexp − ddddd − 13) |
| s 11 11111 | (−1)^{s} × 1.0 × 2\hat{ } (shexp + 1) |
| 0 11 00000 | Zero |
| 1 11 00000 | NaN |
| s 00 pffff | (−1)^{s} × 1.fffff × 2\hat{ } (shexp − p) |
| s 01 pffff | (−1)^{s} × 1.ffff x 2\hat{ } (shexp − p − 2) |
| s 10 p1fff | (−1)^{s} × 1.fff × 2\hat{ } (shexp − p − 4) |
| s 10 p01ff | (−1)^{s} × 1.ff × 2\hat{ } (shexp − p − 6) |
| s 10 p001f | (−1)^{s} × 1.f × 2\hat{ } (shexp − p − 8) |
| s 10 p0001 | (−1)^{s} × 1.0 × 2\hat{ } (shexp − p − 10) |
| s 10 p0000 | (−1)^{s} × 1.0 × 2\hat{ } (shexp − p − 12) |

The payload is made up an encoded exponent difference concatenated with a number (possibly 0) of fraction bits (ff . . . f), where the encoded exponent difference includes a number (possibly 0) of bits set to zero, at least one bit set to one, and a number (possibly 0) of additional bits (p).

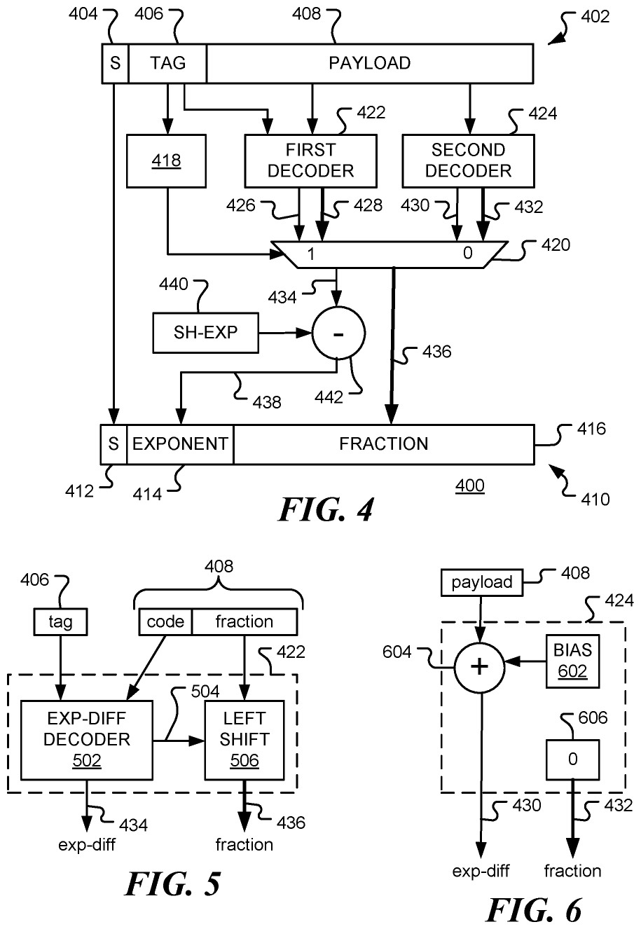

FIG. 4 is a block diagram of a data processing apparatus 400 for converting an enhanced block floating-point (EBFP) number into a floating-point number, in accordance with various embodiments. Input datum 402 is an EBFP number stored as sign bit 404, tag 406 having one or more bits, and payload 408. Storage is provided for an output floating-point (FP) number, stored as a sign bit 412, an exponent 414 and at least a fraction 416 of a significand. When combined with an implicit or hidden “1” bit, fraction 416 provides the significand of the number. Thus, fraction 416 is equivalent to a significand, in that it provides the same information. It will be apparent to those of ordinary skill in the art that apparatus 400 may output a fraction or a significand. Apparatus 400 includes a number of logic units including controller 418, selector 420, first decoder 422 and second decoder 424. Controller 418 is configured to control selector 420 to select between first decoder 422 and second decoder 424 based on tag 406 of an input datum. In FIG. 4, selector 420 is shown on the outputs of the first and second decoders 422, 424. However, the selector may select which decoder produces the outputs by selecting which decoder receives the payload, or which decoder is operated.

First decoder 422 is configured to determine exponent difference 426 and fraction 428 based on the payload 408 of input datum 402. Second decoder 424 is configured to determine exponent difference 430 of the floating-point number based on the payload 408 of the input datum 402, the floating-point number having a designated fraction 432. Selector 420 selects the outputs of the first or second decoders 422, 424 as exponent difference 434 and fraction 436. Exponent 438 of the output floating-point number is determined by subtracting the selected exponent difference 434 from a shared exponent 440 in subtractor 442. Sign bit 412 is determined from sign bit 404. However, sign bit 412 may be modified for certain special values, dependent upon the format chosen for the floating-point number.

The arrangement of the logic units shown in FIG. 4, may be varied without departing from the present disclosure. For example, in an embodiment, the shared exponent may be subtracted within the first and second decoders.

FIG. 5 is a block diagram of a first decoder 422, in accordance with various embodiments. First decoder 422 is used when the payload is in a first format and is a concatenation of a code part and a fraction part. Exponent difference decoder 502 produces exponent difference 434 and shift value 504 from tag 406 and a code part of payload 408 of an input datum. Shifter 506 is configured to left-shift a fraction part of payload 408, according to shift value 504, to produce fraction 428.

FIG. 6 is a block diagram of a second decoder 424, in accordance with various embodiments. Second decoder 424 is used when the payload is in a second format and represents a contribution to an exponent. Second decoder 424 is configured to determine exponent difference 430 by subtracting, in subtractor 604, bias value 602 from the payload 408 of the input datum 402. Fraction 432 is set to a designated value 606, such a “0,” for example.

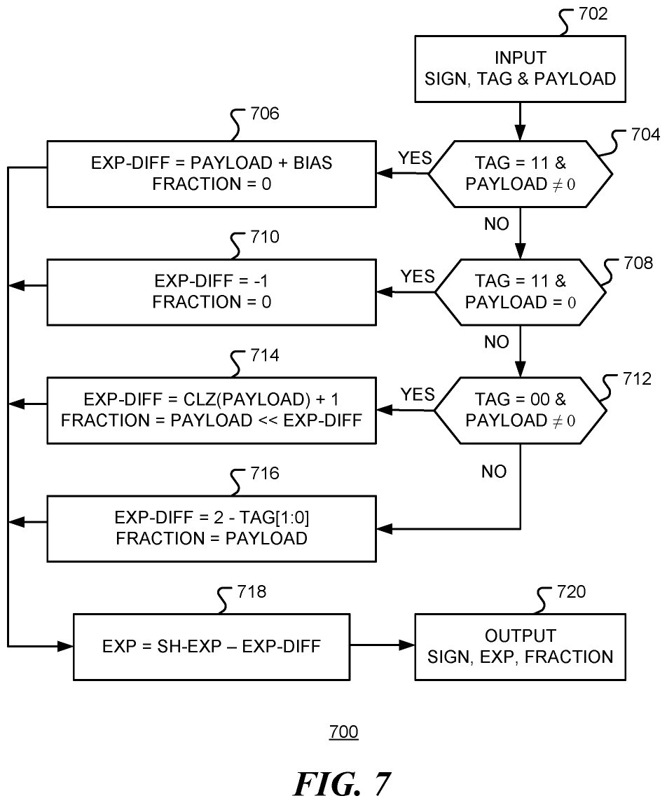

FIG. 7 is a flow chart of a computer-implemented method 700 for converting a number in EBFP format into a number in a floating-point format, in accordance with various representative embodiments. At block 702, an input datum in EBFP format is provided, having a sign, a tag and payload. If the tag equals binary value “11” and the payload is not equal to zero, as depicted by the positive branch from decision block 704, the exponent difference is computed as the payload value plus a bias value at block 706, and the output fraction is set to zero. Otherwise, flow continues to decision block 708. If the tag equals binary value “11” and the payload is equal to zero, as depicted by the positive branch from decision block 708, the exponent difference is set to −1 and the output fraction is set to zero at block 710. Otherwise, flow continues to decision block 712. If the tag value is binary “00” and the payload is not equal to zero, as depicted by the positive branch from decision block 712, the exponent difference is determined by counting the number of leading zeros, in the payload or the payload and tag, (if any) and adding 1. As discussed above, in an alternative embodiment, the number of trailing zeros are counted. The output fraction is produced by shifting the payload left by the exponent difference. The addition of 1 to the number of leading zeros ensures the leading 1 in the payload becomes hidden. For other case, as depicted by the negative branch from decision block 712, the exponent difference is computed by subtracting the tag value from 2, and the output fraction is set equal to the payload.

At block 718, the exponent of the output floating-point number is determined by subtracting the exponent difference from a shared exponent. The sign of the output is copied from the sign of the input and the sign, exponent and fraction of the floating-point number are output at block 720.

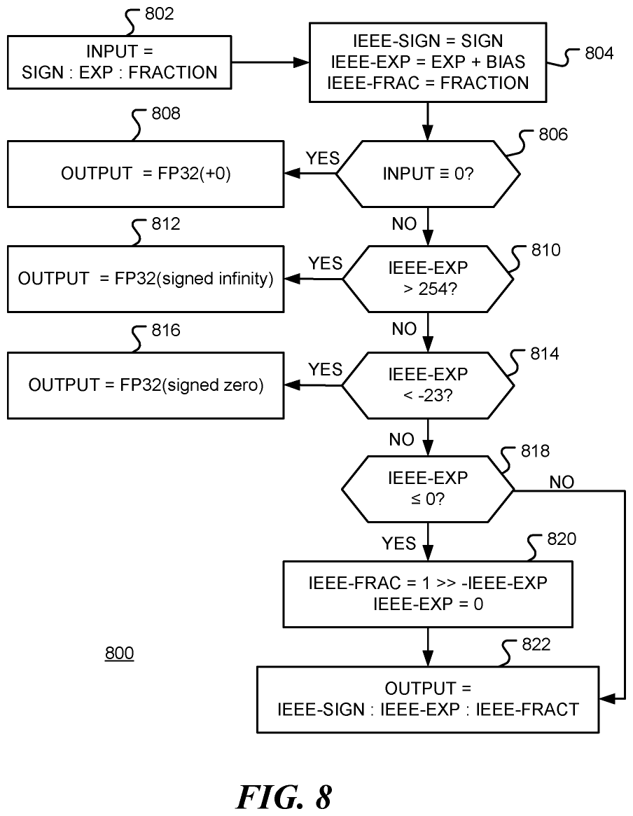

FIG. 8 is a flow chart of a computer-implemented method 800 for converting a floating-point number, decoded from EBFP format as in FIG. 7, to a number in standard, 32-bit, Institute of Electrical and Electronic Engineers (IEEE) floating-point format. At block 802, a sign, exponent and fraction of the decoded EBFP number are provided. At block 804, the IEEE-sign (i.e., the sign of the number in IEEE format) is set to the input and the IEEE-fraction is set to the input fraction. The IEEE-exponent is obtained by adding a bias value (e.g., 127), to the input exponent. When the input represents zero, as depicted by the positive branch from decision block 806, the output is set to value that represents positive zero in the IEEE standard at block 808. Otherwise, when the IEEE-exponent is greater than 254, as depicted by the positive branch from decision block 810, the output is set to the value that represents signed infinity in the IEEE standard at block 812. Otherwise, when the IEEE-exponent is less than −23, as depicted by the positive branch from decision block 814, the output is set to the value that represents signed zero in the IEEE standard at block 816. Otherwise, when the IEEE-exponent is less than zero, as depicted by the positive branch from decision block 818, the IEEE-fraction is determined by right-shifting the value “1” by the negated IEEE-exponent and the IEEE-exponent is set to zero at block 820. Finally, the IEEE-sign, IEEE-exponent and IEEE-fraction are output at block 822. This representation is referred to as a “subnorm,” since the “fraction” part of the output contains a significand that is not normalized. In an alternative embodiment, the output is set to zero when the IEEE-exponent is less than zero.

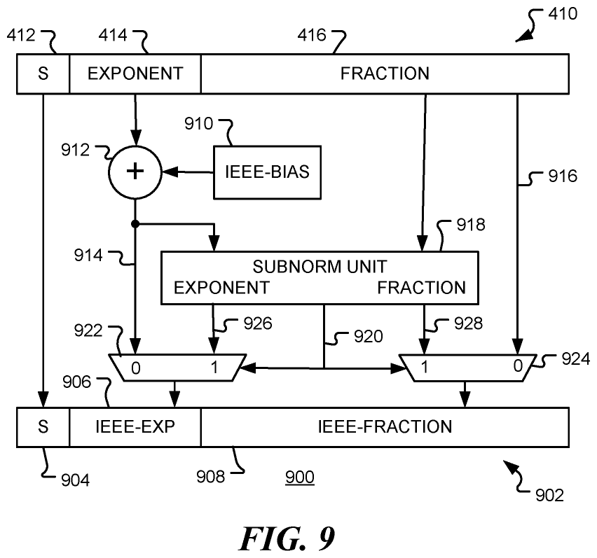

FIG. 9 is a block diagram of a data apparatus 900 for converting a floating-point number 410, decoded from an EBFP number, to a floating-point number 902 in a standard IEEE floating-point format. As described above, the decoded floating-point number 410 includes sign bit 412, exponent 414 and fraction 416. The floating-point number 902 includes sign bit 904, IEEE exponent 906, and IEEE fraction 908. For example, a 32-bit IEEE floating-point number may have one sign-bit, 8 exponent bits and 23 fraction bits. Sign bit 412 is copied to sign bit 904 of the IEEE format. IEEE-bias 910 is added to exponent 414 in adder 912 to produce IEEE exponent 914. IEEE fraction 916 is obtained from fraction 416 of the decoded EBFP number. Subnorm unit 918 is configured to check that IEEE exponent 914 is within an acceptable range to be stored in IEEE exponent 906, and to assert signal 920 when it is not. When signal 920 is not asserted, selector 922 selects IEEE exponent 914 to be stored in IEEE exponent 906 and selector 924 selects IEEE fraction 916 to be stored in IEEE fraction 908. When IEEE exponent 914 is not within the acceptable range, Subnorm unit 918 generates subnorm exponent 926 and subnorm fraction 928. Signal 920 is asserted, and the subnorm exponent and subnorm fraction are stored. Examples of subnorm exponent and fraction determinations are described above.

In some embodiments, an EBFP formatted number occupies an 8-bit word. This enables computations to be made using shorter word lengths. This is advantageous, for example, when a large number of values is being processed or when memory is limited. However, in some applications, such as accumulators, more precision is needed. An EBFP format using 16-bit words is described below. In general, the format using M-bit words, where M can be any number (e.g., 8, 16, 24, 32, 64 etc.).

In one embodiment using 16-bit words, all EBFP16 numbers have an additional eight fraction bits than in EBFP8, while the range of exponent differences is the same as in EBFP8. EBFP16 may be used where a wider storage format is needed and provides better accuracy and a wider exponent range than the “Bfloat” format.

TABLE 8 below gives an example of decoding an EBFP16r2 (radix 2) format with two tag bits. Note that for exponent differences in the range 7-37, the last eight bits of the payload contain the fractional part of the number, while the first 5 bits contain the exponent. In this case, the payload is similar to floating point representation of the input, except that the exponent is to be subtracted from the shared exponent.

TABLE 8

| | Output | |
|---|---|---|
| | Exponent | |
| Input | Difference | Output |
| Sign, Tag[1:0], Payload[12:0] | (CLZ) | Significand |
| s 10 fffff ffffffff | 0 | 1.fffff ffffffff |
| s 01 fffff ffffffff | 1 | 1.fffff ffffffff |
| s 00 1ffff ffffffff | 2 | 1.ffff ffffffff |
| s 00 01fff ffffffff | 3 | 1.fff ffffffff |
| s 00 001ff ffffffff | 4 | 1.ff ffffffff |
| s 00 0001f ffffffff | 5 | 1.f ffffffff |
| s 00 00001 ffffffff | 6 | 1. ffffffff |
| X 00 00000 xxxxxxxx | | Zero |
| s 11 00000 xxxxxxxx | 0 | 10.0 |
| s 11 eeeee ffffffff | 7-37 | 1. ffffffff |

TABLE 9 below gives an example of decoding an EBFP16r4 (radix 4) format with two tag bits.

TABLE 9

| Input | Output | |
|---|---|---|
| Sign, Tag[1:0], Payload[12:0] | Exponent | Output |
| p = 0 or 1 | Difference | Significand |
| s 10 fffff ffffffff | 0 | 1.fffff ffffffff |
| s 01 pffff ffffffff | 1 + p | 1.ffff ffffffff |
| s 00 1pfff ffffffff | 3 + p | 1.fff ffffffff |
| s 00 01pff ffffffff | 5 + p | 1.ff ffffffff |
| s 00 001pf ffffffff | 7 + p | 1.f ffffffff |
| s 00 0001p ffffffff | 9 + p | 1. ffffffff |
| s 00 00001 ffffffff | 11 | 1. ffffffff |
| X 00 00000 xxxxxxxx | | Zero |
| s 11 00000 xxxxxxxx | 0 | 10.0 |
| s 11 eeeee ffffffff | 12-42 | 1. ffffffff |

In one embodiment, an EBFP number is encoded in a first format of the form “s:tag:P:1:F” or second format of the form “s:tag:D”. where “s” is a sign-bit, “tag” is one or more bits of an encoding tag, “P” is R encoded exponent difference bits, “F” is a fraction and “D” is an exponent difference. Except for a subset of tag values, the floating-point number represented has significand 1.F and exponent difference 2^{R}×(tag+CLZ)+P, where CLZ is the number of leading zeros in the fraction F. For a first special tag value (e.g., all ones), the second format is used where the exponent difference is D plus a bias offset.

Some example embodiments for an 8-bit EBFP number are given below in TABLE 10.

TABLE 10
1-bit tag, R = 0

| Tag:Payload | Floating-Point Equivalent |
|---|---|
| 1 dddddd | 1.0 * 2\hat{ } (shexp − dddddd − 5) |
| 1 111111 | 1.0 * 2\hat{ } (shexp + 1) |
| 1 000000 | Zero |
| 0 1fffff | 1.fffff * 2\hat{ }shexp |
| 0 01ffff | 1.ffff * 2\hat{ } (shexp − 1) |
| 0 001fff | 1.fff * 2\hat{ } (shexp − 2) |
| 0 0001ff | 1.ff * 2\hat{ } (shexp − 3) |
| 0 00001f | 1.f * 2\hat{ } (shexp − 4) |
| 0 000001 | 1.1 * 2\hat{ } (shexp − 5) |
| 0 000000 | 1.0 * 2\hat{ } (shexp − 5) |

In contrast with the embodiments discussed above, the positions of the one or more “p” bits are fixed as the leading bits in the payload. With an 8-bit data, R may be in the range 0-5. Some examples are listed below in TABLES 11-15.

TABLE 11
1-bit tag, R = 1

| Tag:Payload | Floating-Point Equivalent |
|---|---|
| 1 dddddd | 1.0 * 2\hat{ } (shexp − dddddd − 8) |
| 1 111111 | 1.0 * 2\hat{ } (shexp + 1) |
| 1 000000 | Zero |
| 0 p1ffff | 1. ffff * 2\hat{ } (shexp − p) |
| 0 p01fff | 1. fff * 2\hat{ } (shexp − p − 2) |
| 0 p001ff | 1.ff * 2\hat{ } (shexp − p − 4) |
| 0 p0001f | 1.f * 2\hat{ } (shexp − p − 6) |
| 0 p00001 | 1.1 * 2\hat{ } (shexp − p − 8) |
| 0 p00000 | 1.0 * 2\hat{ } (shexp − p − 8) |

TABLE 12
2-bit tag, R = 0

| Tag:Payload | Floating-Point Equivalent |
|---|---|
| 11 ddddd | 1.0 * 2\hat{ } (shexp − ddddd − 6) |
| 11 11111 | 1.0 * 2\hat{ } (shexp + 1) |
| 11 00000 | Zero |
| 00 fffff | 1.fffff * 2\hat{ }shexp |
| 01 fffff | 1.fffff * 2\hat{ } (shexp − 1) |
| 10 1ffff | 1.ffff * 2\hat{ } (shexp − 2) |
| 10 01fff | 1.fff * 2\hat{ } (shexp − 3) |
| 10 001ff | 1.ff * 2\hat{ } (shexp − 4) |
| 10 0001f | 1.f * 2\hat{ } (shexp − 5) |
| 10 00001 | 1.1 * 2\hat{ } (shexp − 6) |
| 10 00000 | 1.0 * 2\hat{ } (shexp − 6) |

TABLE 13
2-bit tag, R = 1

| Tag:Payload | Floating-Point Equivalent |
|---|---|
| 11 ddddd | 1.0 * 2\hat{ } (shexp − ddddd − 10) |
| 11 11111 | 1.0 * 2\hat{ } (shexp + 1) |
| 11 00000 | Zero |
| 00 pffff | 1.fffff * 2\hat{ } (shexp − p) |
| 01 pffff | 1.ffff * 2\hat{ } (shexp − p − 2) |
| 10 p1fff | 1.fff * 2\hat{ } (shexp − p − 4) |
| 10 p01ff | 1.ff * 2\hat{ } (shexp − p − 6) |
| 10 p001f | 1.f * 2\hat{ } (shexp − p − 8) |
| 10 p0001 | 1.1 * 2\hat{ } (shexp − p − 10) |
| 10 p0000 | 1.0 * 2\hat{ } (shexp − p − 10) |

TABLE 14
1-bit tag, R = 2

| Tag:Payload | Floating-Point Equivalent |
|---|---|
| 1 dddddd | 1.0 * 2\hat{ } (shexp − dddddd − 15) |
| 1 111111 | 1.0 * 2\hat{ } (shexp + 1) |
| 1 000000 | Zero |
| 0 pp1fff | 1.fff * 2\hat{ } (shexp − pp) |
| 0 pp01ff | 1.ff * 2\hat{ } (shexp − pp − 4) |
| 0 pp001f | 1.f * 2\hat{ } (shexp − pp − 8) |
| 0 pp0001 | 1.1 * 2\hat{ } (shexp − pp − 12) |
| 0 pp0000 | 1.0 * 2\hat{ } (shexp − pp − 12) |

TABLE 15
3-bit tag, R = 1

| Tag:Payload | Floating-Point Equivalent |
|---|---|
| 111 dddd | 1.0 * 2\hat{ } (shexp − dddd − 16) |
| 111 1111 | 1.0 * 2\hat{ } (shexp + 1) |
| 111 0000 | Zero |
| 110 p1ff | 1.ff * 2\hat{ } (shexp − p − 12) |
| 110 p01f | 1.f * 2\hat{ } (shexp − p − 14) |
| 110 p00f | 1.f * 2\hat{ } (shexp − p − 16) |
| xxx pfff | 1.fff * 2\hat{ } (shexp − p − 2*xxx) |

In TABLE 15, “xxx” is any 3-bit combination except for the special values “111” and “110”.

Still further embodiments are given in TABLES 16-18.

TABLE 16
3-bit Tag

| | |
|---|---|
| 111 dddd | 1.0 * 2\hat{ } (shexp − 21 − dddd) |
| 111 1111 | 1.0 * 2\hat{ } (shexp + 1) |
| 111 0000 | e.g. Zero (S = 0); NaN/Inf (S = 1) |
| 0tt pfff | 1.fff * (2\hat{ }shexp − ttp) |
| 10t ppff | 1.ff * (2\hat{ }shexp − tpp − 8) |
| 110 p1ff | 1.ff * 2\hat{ } (shexp − p − 16) |
| 110 p01f | 1.f * 2\hat{ } (shexp − p − 18) |
| 110 p00f | 1.f * 2\hat{ } (shexp − p − 20) |

TABLE 17
4-bit Tag

| 0ttt fff | 1.fff * 2\hat{ } (shexp − ttt) |
|---|---|
| 10tt pff | 1.ff * 2\hat{ } (shexp − ttp − 8) |
| 110t pff | 1.ff * 2\hat{ } (shexp − tp − 16) |
| 1110 ppf | 1.f * 2\hat{ } ( shexp − pp − 20) |
| 1111 ddd | 1.0 * 2\hat{ } (shexp − 23 − ddd) |
| 1111 111 | 1.0 * 2\hat{ } (shexp + 1) |
| 1111 000 | Zero (S = 0); NaN/Inf (S = 1) |

TABLE 18
4-bit Tag (0 ↔ 1)

| 1ttt fff | 1.fff * 2\hat{ } (shexp − ttt) |
|---|---|
| 01tt pff | 1.ff * 2\hat{ } (shexp − ttp − 8) |
| 001t pff | 1.ff * 2\hat{ } (shexp − tp − 16) |
| 0001 ppf | 1.f * 2\hat{ } (shexp − pp − 20) |
| 0000 ddd | 1.0 * 2\hat{ } (shexp −23 − ddd) |
| 0000 111 | 1.0 * 2\hat{ } (shexp + 1) |
| 0000 000 | Zero (S = 0); NaN/Inf (S = 1) |

TABLE 18 is equivalent to TABLE 17 and illustrates how the use of zero and one in the part of the encoding shown in bold font may be reversed.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or that is has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard-wired logic may be used to construct alternative equivalent embodiments of the present disclosure.

Dedicated or reconfigurable hardware components used to implement the disclosed mechanisms may be described, for example, by instructions of a hardware description language (HDL), such as VHDL, Verilog or RTL (Register Transfer Language), or by a netlist of components and connectivity. The instructions may be at a functional level or a logical level or a combination thereof. The instructions or netlist may be input to an automated design or fabrication process (sometimes referred to as high-level synthesis) that interprets the instructions and creates digital hardware that implements the described functionality or logic.

The HDL instructions or the netlist may be stored on non-transitory computer readable medium such as Electrically Erasable Programmable Read Only Memory (EEPROM); non-volatile memory (NVM); mass storage such as a hard disc drive, floppy disc drive, optical disc drive; optical storage elements, magnetic storage elements, magneto-optical storage elements, flash memory, core memory and/or other equivalent storage technologies without departing from the present disclosure. Such alternative storage devices should be considered equivalents.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added or operations can be deleted without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. An apparatus, comprising:
a first decoder;
a second decoder;
a controller configured to select between the first decoder and the second decoder based on a tag value of an input datum, the input datum including the tag value, a sign bit, and a payload;
storage for a floating-point number including the sign bit of the input datum, an exponent, and at least a fractional part of a significand; and
a subtractor configured to subtract an exponent difference, received from the selected first or second decoder, from a shared exponent to provide the exponent of the floating-point number to the storage,
where the first decoder is configured to:
determine the exponent difference and a fraction of the floating-point number based on the payload of the input datum, and
provide the fraction of the floating-point number to the storage, and
where the second decoder is configured to:
determine the exponent difference based on the payload of the input datum, and
provide a designated fraction of the floating-point number to the storage.

2. The apparatus of claim 1, where the first decoder is configured to:
for a first tag value:
determine a number of leading zeros in a designated part of the payload;
determine an exponent difference based on the number of leading zeros, and
shift the payload by the exponent difference to produce a fractional part of the significand of the floating-point number; and
for a second tag value:
set the fractional part of the significand of the floating-point number to the payload; and
determine the exponent difference based on the second tag value.

3. The apparatus of claim 1, where the second decoder is configured to:
set a fractional part of the significand to zero; and
determine the exponent difference of the floating-point number by:
setting the exponent difference to negative one when the payload is first designated value, and
adding a bias value to the payload to produce the exponent difference when the payload is not the first designated value

4. The apparatus of claim 1, where:
said provide the exponent of the floating-point number to the storage includes:
add a bias value to the exponent of the floating-point number to produce a biased exponent, and
when the biased exponent is within a designated range, provide the biased exponent to the storage; and
the fractional part of the significand is provided to the storage.

5. The apparatus of claim 1, where said provide the exponent of the floating-point number to the storage includes:
when the exponent is greater than a maximum representable value, provide a value designated for infinity or the maximum representable value to the storage;
when the exponent is less than a minimum value, provide a value of zero to the storage; and
when the exponent is within a designated range between the maximum value and the minimum value:
when the first decoder is selected, shift the payload based on the tag value, where the shifted payload is provided to the storage as the significand, and
when the second decoder is selected, set the exponent in the storage to zero, where a bit of the significand in the storage is set to zero to indicate the exponent of the floating-point number.

6. The apparatus of claim 1, where the storage for the floating-point number includes:
one bit of storage for the sign bit;
eight bits of storage for the exponent; and
23 bits of storage for at least the fractional part of the significand.

7. The apparatus of claim 1, further comprising storage for an input datum including a sign bit, a 2-bit tag and a 5-bit or 13-bit payload.

8. The apparatus of claim 1, further comprising storage for an input datum including a sign bit, a 1-bit tag and a 6-bit or 14-bit payload.

9. The apparatus of claim 1, further comprising storage for an input datum including a sign-bit, a tag, and a payload, the tag identifying when the payload contains:
R encoded exponent difference bits, a “one” bit adjacent to L zeros, and a T-bit fraction, where R, L and T are greater than or equal to zero; or
an exponent difference.

10. A non-transitory computer readable medium storing a netlist or instructions of a hardware description language that, when interpreted by an automated design or fabrication process, generate the apparatus according to claim 1.

11. A method, comprising:
determining a format of an input datum based on a tag value of the input datum;
for a first format:
determining an exponent difference and a significand of a floating-point number based on a payload of the input datum; and
for a second format:
determining the exponent difference of the floating-point number based on the payload of the input datum, the floating-point number having a designated significand,
subtracting the exponent difference from a shared exponent to determine an exponent of the floating-point number, and
storing a sign of the input datum, the exponent of the floating-point number and the significand of the floating-point number.

12. The method according to claim 11, where storing the significand of the floating-point number includes storing a fractional part of the significand, and where a leading bit of the significand is hidden.

13. The method according to claim 11, where, for the first format, said determining the exponent difference and significand of the floating-point number includes:
for a first tag value:
determining a number of leading zeros in a designated part of the payload;
determining the exponent difference based on the number of leading zeros, and
shifting the payload left by the exponent difference to produce a fractional part of the significand of the floating-point number; and
for a second tag value:
setting the fractional part of the significand of the floating-point number to the payload, and
determining the exponent difference of the floating-point number based on the second tag value.

14. The method according to claim 11, where, for the second format, determining the exponent difference of the floating-point number includes:
setting a fractional part of the significand to zero;
when the payload is a first designated value, setting the exponent difference to negative one; and
when the payload is not the first designated value, subtracting the payload and a bias value from the shared exponent to determine the exponent of the floating-point number.

15. The method according to claim 11, where said storing the sign of the input datum, the exponent of the floating-point number and the significand of the floating-point number includes storing the sign of the input datum, the exponent of the floating-point number and the significand of the floating-point number in an Institute of Electrical and Electronic Engineers (IEEE) standard floating-point format.

16. The method according to claim 11, where said storing the sign of the input datum, the exponent of the floating-point number and the significand of the floating-point number includes storing one bit for the sign bit, eight bits for the exponent, and 23 bits for at least a fractional part of the significand.

17. The method according to claim 11, where the input datum includes a sign bit, a 2-bit tag and a 5-bit or 13-bit payload.

18. The method according to claim 11, where the input datum includes a sign bit, a 1-bit tag and a 6-bit or 14-bit payload.

19. The method of claim 11, where the input datum includes a sign-bit, a tag, and a payload, the tag identifying when the payload contains:
a D-bit exponent difference; or
R encoded exponent difference bits, a “one” bit adjacent to L zeros, and a T-bit fraction, where R, L and T are greater than, or equal to, zero.

20. A non-transitory computer readable medium storing a netlist or instructions of a hardware description language that, when interpreted by an automated design or fabrication process, generate digital hardware configured to implement the method according to claim 11.
